(19) United States
(12) Patent Application Publication
(10) Pub. No.: US 2026/0267478 A1
(43) Pub. Date: Sep. 10, 2026

(54) DISPLAY METHOD AND NON-TRANSITORY COMPUTER-READABLE STORAGE MEDIUM STORING DISPLAY PROGRAM

(71) Applicant: SEIKO EPSON CORPORATION, Tokyo (JP)

(72) Inventor: Yusuke YAMADA, Shiojiri (JP)

(21) Appl. No.: 19/553,649

(22) Filed: Mar. 2, 2026

(30) Foreign Application Priority Data
Mar. 4, 2025 (JP) 2025-033409

(51) Int. Cl. G06F 3/0483; G06F 3/0482; G06F 3/04845; G06T 3/60

(52) U.S. Cl. CPC G06F 3/0483; G06F 3/0482; G06F 3/04845; G06T 3/60

(57) ABSTRACT

A display method rotates each of a plurality of images arranged on a first virtual axis around a corresponding one of second virtual axes intersecting the first virtual axis, further rotates the plurality of images around the first virtual axis, and displays the plurality of images on a display section. The display method includes, in a case where the plurality of images are to be arranged on the first virtual axis, and an image randomly selected from among the plurality of images satisfies a predetermined condition, making a width of a first interval between the randomly selected image and an image adjacent to the randomly selected image different from a reference width of the first interval in a case where the randomly selected image does not satisfy the predetermined condition.

The present application is based on, and claims priority from JP Application Serial Number 2025-033409, filed March 4, 2025, the disclosure of which is hereby incorporated by reference herein in its entirety.

### BACKGROUND

### 1. Technical Field

The present disclosure relates to a display method and a non-transitory computer-readable storage medium storing a display program.

### 2. Related Art

A viewer that enables a user to view an electronic document is known. JP-A-2023-85322 discloses a configuration in which thumbnail images indicating respective pages included in a document are displayed side by side, and when any of the thumbnail images is operated, an original image of the thumbnail image is displayed, thereby enabling a user to view details of the original image.

A usage mode of the user may be to jump to a page far away from a currently viewed page, temporarily view the page, and then return to the original page again. However, in the related art, it is not easy for the user to search for the original page in order to return from the page as a jump destination to the original page, and it is desired to improve operability.

### SUMMARY

To solve the above-described problem, according to an aspect of the present disclosure, there is provided a display method that rotates each of a plurality of images arranged on a first virtual axis around a corresponding one of second virtual axes intersecting the first virtual axis, further rotates the plurality of images around the first virtual axis, and displays the plurality of images on a display section, the display method including, in a case where the plurality of images are to be arranged on the first virtual axis, and an image randomly selected from among the plurality of images satisfies a predetermined condition, making a width of a first interval between the randomly selected image and an image adjacent to the randomly selected image different from a reference width of the first interval in a case where the randomly selected image does not satisfy the predetermined condition.

To solve the above-described problem, according to another aspect of the disclosure, there is provided a non-transitory computer-readable storage medium storing a display program, the display program causing a computer to function as an image acquiring section that acquires a plurality of images to be displayed, and an image processing section that rotates each of the plurality of images arranged on a first virtual axis around a corresponding one of second virtual axes intersecting the first virtual axis, further rotates the plurality of images around the first virtual axis, and displays the plurality of images on a display section, wherein in a case where the plurality of images are to be arranged on the first virtual axis, and an image randomly selected from among the plurality of images satisfies a predetermined condition, the image processing section makes a width of a first interval between the randomly selected image and an image adjacent to the randomly selected image different from a first interval between the randomly selected image and the image adjacent to the randomly selected image in a case where the randomly selected image does not satisfy the predetermined condition.

### BRIEF DESCRIPTION OF THE DRAWINGS

FIG. 1 is a block diagram illustrating a configuration of a display apparatus.

FIG. 2 is a diagram illustrating an example (single-page display) of a display screen.

FIGS. 3A, 3B, and 3C are schematic diagrams for explaining rotation of an image.

FIG. 4 is a diagram for explaining rotation angles according to positions.

FIG. 5 is a diagram illustrating a user operation and an example of a displayed image bundle.

FIG. 6 is a diagram illustrating a user operation and an example of the displayed image bundle.

FIG. 7 is a diagram illustrating an example of the displayed image bundle.

FIG. 8 is a diagram illustrating an example (double-page spread display) of the display screen.

FIG. 9 is a flowchart illustrating a display process.

FIG. 10 is a flowchart illustrating an image bundle generation process.

FIG. 11 is a schematic diagram for explaining an example of intervals between images.

FIG. 12 is a schematic diagram for explaining a width of a double-page spread.

FIG. 13 is a flowchart illustrating a target image switching process.

FIG. 14 is a diagram illustrating an example of a displayed document list.

### DESCRIPTION OF EMBODIMENTS

Embodiments of the present disclosure will be described in the following order.
(1) Configuration of Display Apparatus
(2) Display Process
(2-1) Image Bundle Generation Process
(3) Target Image Switching Process
(4) Other Embodiments

### 1 Configuration of Display Apparatus

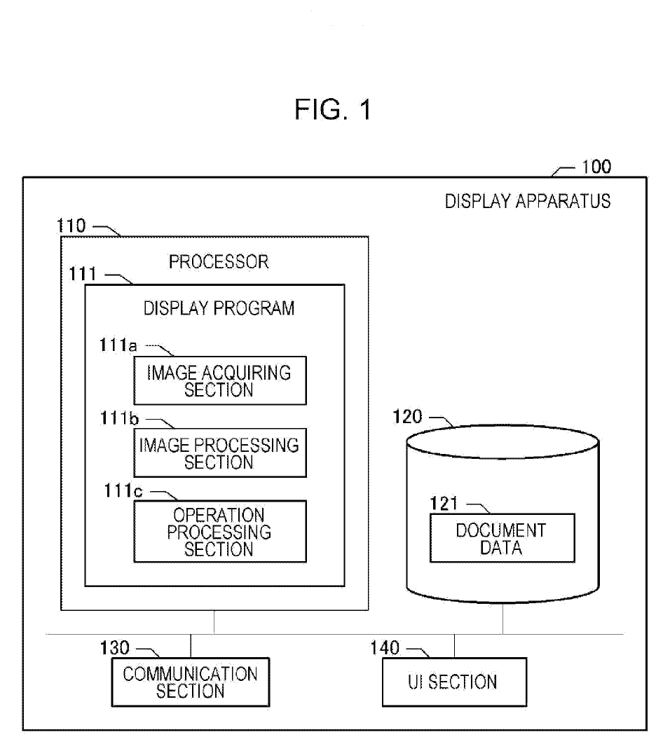

FIG. 1 is a block diagram illustrating a configuration of a display apparatus 100 according to an embodiment of the present disclosure. The display apparatus 100 is an apparatus for a user to view and edit an electronic document. For example, the display apparatus 100 is configured as, for example, a tablet terminal, a smartphone, an electronic book reader, a viewer, a PC, or the like. The display apparatus 100 includes a processor 110, a storage medium 120, a communication section 130, and a UI section 140.

The processor 110 includes a VRAM, a RAM, a ROM, a CPU, a GPU, and the like and can execute various programs including a display program 111 stored in the storage medium 120 or the ROM. The display program 111 causes the processor 110 to implement a function of displaying, on a display section, an image of each page included in the electronic document and performing processing such as page turning or page jumping in response to a user's operation. The storage medium 120 is a nonvolatile memory. Various programs and various data (not illustrated) are stored in the storage medium 120. In the present embodiment, document data 121 as the electronic document to be displayed by the display program 111 is stored in the storage medium 120. Although only one document data piece 121 is illustrated in FIG. 1, a plurality of document data pieces may be stored.

The document data 121 includes images indicating a plurality of respective pages. The document data 121 also includes information indicating the number of the pages included in the document data 121 and vertical and horizontal sizes of the images indicating the respective pages.

The communication section 130 includes a communication interface for performing communication in accordance with various wired or wireless communication protocols. The processor 110 can communicate with another apparatus and transmit and receive various data to and from the other apparatus by the communication section 130. In a case where the display apparatus 100 includes a mounting section on which a removable memory is mounted, the processor 110 can transmit and receive various data to and from the removable memory mounted on the mounting section by the communication section 130. The document data 121 may be received from the other apparatus by the communication section 130 or may be created by the user using an application executable by the display apparatus 100.

The UI section 140 includes a touch panel display and keys. The UI section 140 may include a microphone and a speaker. The processor 110 may be configured to communicate with a pointing device (not illustrated) and a keyboard (not illustrated) via the communication section 130 and receive operations by the pointing device and the keyboard.

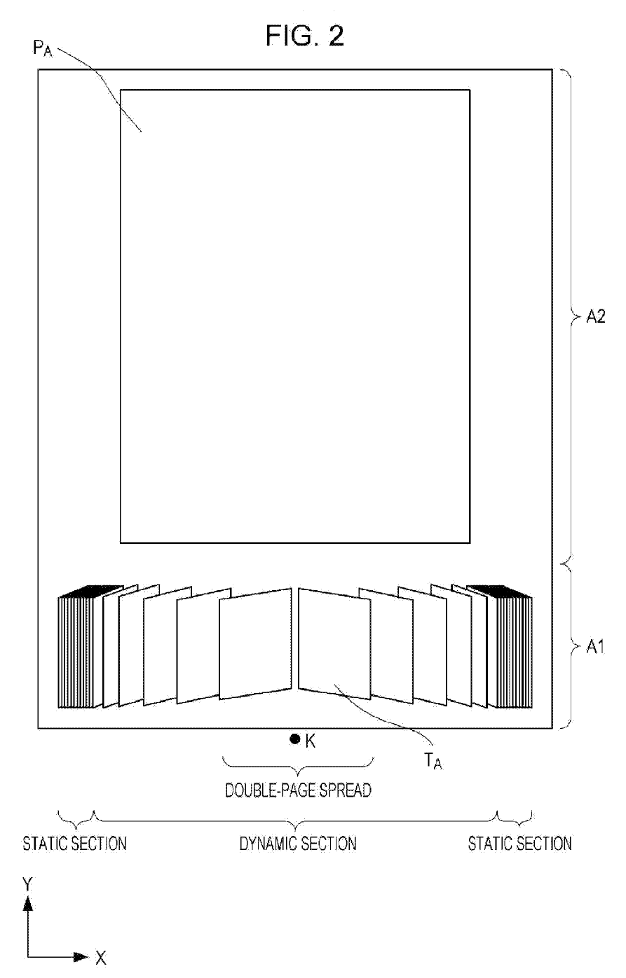

FIG. 2 illustrates an example of the pages of the document data 121 displayed on the display section by the display program 111. A screen displayed by the display program 111 includes an image bundle display region A1 and a main display region A2. In the image bundle display region A1, thumbnail images indicating the plurality of respective pages included in the document data are arranged and displayed in the order of the pages. In the main display region A2, a target page among the plurality of pages is displayed in a size larger than those of the thumbnail images. A mode in which an image for a single page is displayed in the main display region A2 as illustrated in FIG. 2 is referred to as a single-page display in the present specification.

In the present embodiment, among the plurality of images in the image bundle display region A1, an image at the left end of the image bundle display region A1 indicates the first page of the document data 121, and an image at the right end of the image bundle display region A1 indicates the last page of the document data 121.

In the present embodiment, a thumbnail image indicating each of the pages of the document data 121 displayed in the image bundle display region A1 is referred to as an "image", and a thumbnail image indicating a target page among the pages is referred to as a target image. An image indicating the target page displayed in the main display region A2 is referred to as an "enlarged image". T_{A} is the target image, and P_{A} is the enlarged image of the target image. For example, in a case where the target image T_{A} is a thumbnail image indicating the sixtieth page, the enlarged image P_{A} is an image (displayed larger than the thumbnail image) indicating the sixtieth page.

In the image bundle display region A1, each of the images is generated and displayed as follows. Specifically, in a virtual space, an XY plane (corresponding to XY in the display section of the UI section 140) defined by an X axis and a Y axis orthogonal to the X axis, and a QM plane defined by a first virtual axis Q and second virtual axes M orthogonal to the first virtual axis Q are defined. The X axis and the first virtual axis Q are parallel to each other. The Y axis and the second virtual axes M are parallel to each other. The processor 110 rotates each of the plurality of images arranged on the first virtual axis Q around a corresponding one of the second virtual axes M intersecting the first virtual axis Q, rotates the plurality of images around the first virtual axis Q, and displays, as an image bundle, images obtained by performing parallel projection of the images rotated around the first virtual axis Q onto the XY plane. In this way, the processor 110 generates a bird's-eye view image obtained by viewing the image bundle arranged in the virtual space from any viewpoint in the virtual space, and displays the bird's-eye view image in the image bundle display region A1.

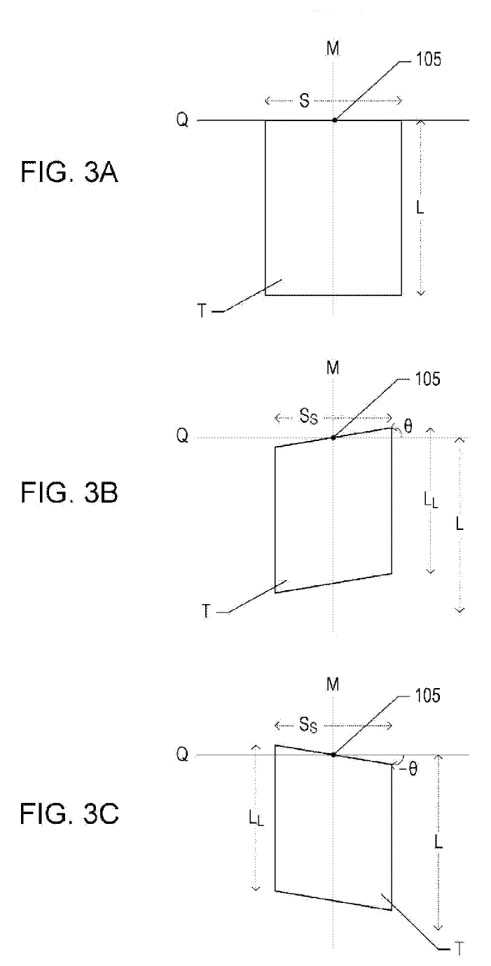

FIG. 3A illustrates a state in which an image T is arranged on a plane defined by the first virtual axis Q and a second virtual axis M orthogonal to the first virtual axis Q such that a midpoint 105 of the image T in a width direction of the image T overlaps the second virtual axis M. The state illustrated in FIG. 3A is a state of a front view of the image T viewed from the front side of the display apparatus 100. FIG. 3B illustrates an image obtained by rotating the image T around the second virtual axis M by an angle θ from the state illustrated in FIG. 3A so as to cause the rotated image T to face the right side, rotating the rotated image T around the first virtual axis Q by a predetermined angle, and performing parallel projection of the rotated image T onto the XY plane (a state viewed from a viewpoint not illustrated). FIG. 3C illustrates an image obtained by rotating the image T around the second virtual axis M by an angle -θ from the state illustrated in FIG. 3A so as to cause the rotated image T to face the left side, rotating the rotated image T around the first virtual axis Q by a predetermined angle, and performing parallel projection of the rotated image T onto the XY plane (a state viewed from a viewpoint not illustrated). When the image having a width S and a height L is projected in parallel onto the XY plane through the above-described rotations, the length (width of the image) of the image in the X-axis direction is S_{S} (< S), and the length (height of the image) of the image in the Y-axis direction is L_{L} (< L)

As illustrated in FIG. 2, the target image T_{A} is displayed in a double-page spread with an image adjacent to the target image T_{A} and indicating any one of previous and next pages of the page indicated by the target image T_{A}. In the present specification, a double-page spread display is to display pages such that the pages face each other, like left and right pages of an opened book. In the example illustrated in FIG. 2, the target image T_{A} is a right image out of two images constituting a double-page spread image, and is rotated and displayed so as to face the left side with respect to a state of a front view of the target image T_{A} viewed from the front side of the display apparatus 100. An image T_{A-1} is a left image out of the two images constituting the double-page spread image, and is rotated and displayed so as to face the right side with respect to the state of the front view of the target image T_{A}.

Similarly, an image group located on the right side of the double-page spread image is rotated and displayed so as to face the left side with respect to the state of the front view, and an image group located on the left side of the double-page spread image is rotated and displayed so as to face the right side with respect to the state of the front view.

As illustrated in FIG. 2, the image bundle is divided into a static section and a dynamic section. The static section is a section in which images are arranged at equal intervals except for an exceptional case to be described later, and the dynamic section is a section in which adjacent images are arranged at a wider interval than in the static section. In a case where the static section includes a certain image satisfying a predetermined condition to be described later and a portion within an interval (first interval) between the certain image and an image adjacent to the certain image, the first interval is an exception to the equal intervals. In a case where the double-page spread image is included in the static section, the interval between the two images constituting the double-page spread image is an exception to the equal intervals in the static section. In the present embodiment, an interval between images is a distance between a midpoint of a certain image out of the images in the width direction of the certain image and a midpoint of the other image adjacent to the certain image in the width direction of the other image.

The image bundle is divided into the static section and the dynamic section based on a predetermined criterion. Various criteria for the division into the static section and the dynamic section are conceivable. However, for example, a predetermined number of consecutive images (10 images in the example illustrated in FIG. 2) including an image displayed at a position closest to a central portion K may be set as images in the dynamic section, and the other images may be set as images in the static section. In the present embodiment, the central portion K is, for example, a central portion of a region occupied for displaying the image bundle in the image bundle display region A1 in the width direction (parallel to the X axis) of the region. The central portion K may be a central portion of the dynamic section in the width direction.

In the dynamic section, images are arranged and displayed such that an interval between images is wider as a distance from the central portion K to the images in the left-right direction is shorter. In the static section, images are displayed at intervals that are narrower than an interval between images in the dynamic section and are equal intervals regardless of a distance from the central portion K. Since an image closer to the central portion K has a wider interval between the image and an image adjacent to the image, the user can easily visually recognize the content of the image.

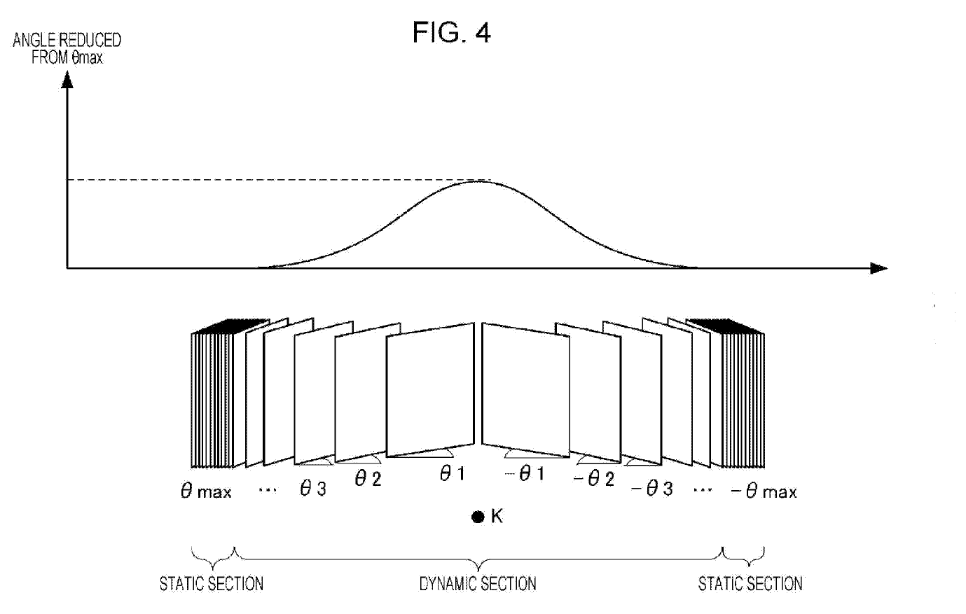

As illustrated in FIG. 4, an absolute value of a rotation angle of all the images in the static section is the maximum value (θmax) among absolute values of rotation angles of the images displayed as the image bundle. In the dynamic section, an absolute value of a rotation angle of an image closer to the central portion K with respect to the state of the front view is smaller than an absolute value of a rotation angle of an image farther from the central portion K with respect to the state of the front view (the closer to the central portion K an image is, the larger a rotation angle of the image reduced from the maximum value θmax is). That is, since an image closer to the central portion K is displayed in a state closer to the front view, the user can easily visually recognize the content of the image.

In the present embodiment, the processor 110 receives a touch operation on the touch panel display in a state where the plurality of images are displayed in the image bundle display region A1. When the processor 110 detects that an operation of swiping the image bundle displayed in the image bundle display region A1 in the left or right direction has been performed, the processor 110 moves a display position of each of the images in the swipe direction in accordance with the operation and displays the images. As a result, the distance from the central portion K to each of the images in the dynamic section is changed.

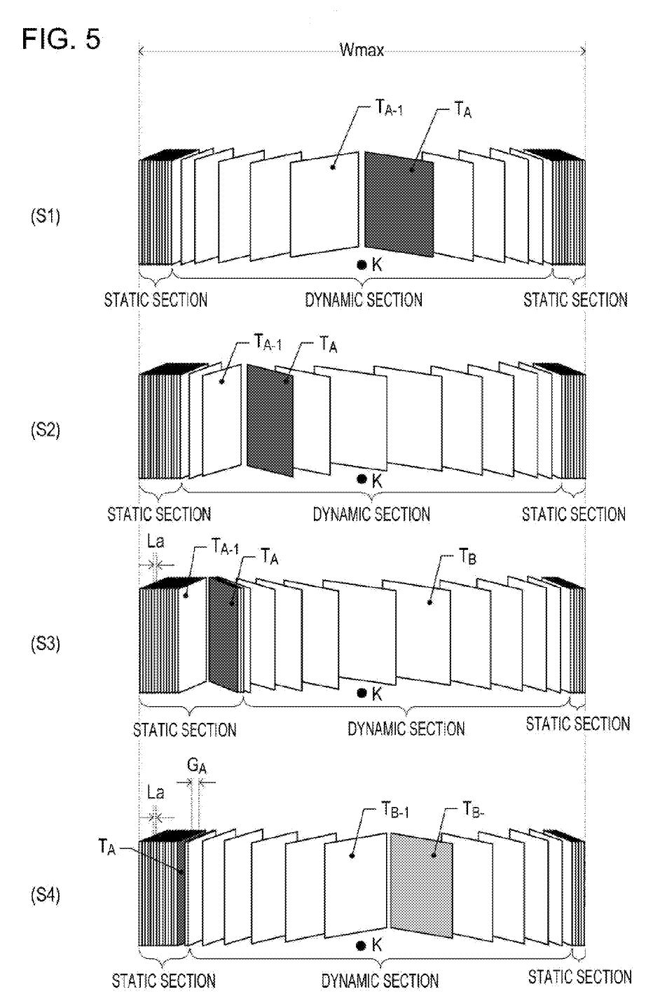

FIG. 5 illustrates an example of the image bundle displayed in the image bundle display region A1 in response to a user operation. Wmax is a width (entire occupancy width) of a region occupied for displaying the entire image bundle. An image illustrated in dark gray in FIG. 5 is the target image T_{A}. For example, when the user swipes the dynamic section from the right to the left from a state indicated by (S1) in FIG. 5, the target image T_{A} is moved to the left side and displayed as indicated by (S2). In the state indicated by (S2), the target image T_{A} and the image T_{A-1} (in this example, the image T_{A-1}is adjacent to the left side of the target image T_{A}) displayed in a double-page spread together with the target image T_{A} maintain a double-page spread display, but absolute values of rotation angles of the target image T_{A} and the image T_{A-1} increase because the distances from the central portion K to the target image T_{A} and the image T_{A-1} increase. As described above, an absolute value of a rotation angle of an image close to the central portion K is small, and the user can easily visually recognize the content of the image. By moving a display position of an image in the left-right direction by swiping in the left-right direction, the user can bring an image of which an outline is to be checked in the image bundle display region A1 closer to the central portion K and visually recognize the outline.

When the user performs swiping from the right to the left again from the state indicated by (S2) and the target image T_{A} is arranged in the static section, the target image T_{A} and the previous image T_{A-1} are displayed in a double-page spread so as to face each other as indicated by (S3). The target image T_{A}, an image adjacent to the target image T_{A} on the right side of the target image T_{A}, the image T_{A-1}, and an image adjacent to the image T_{A-1} on the left side of the image T_{A-1} are displayed such that the interval between target image T_{A} and the image adjacent to the target image T_{A} on the right side and the interval between the image T_{A-1} and the image adjacent to the image T_{A-1} on the left side are equal to each other and equal to a reference width in the static section. The reference width in the static section is La calculated as described later.

When an image other than the target image T_{A} is tapped in the state indicated by (S3), the processor 110 sets the tapped image as a new target image, and displays an image of a page corresponding to the new target image in the main display region A2 (see FIG. 2). If the tapped image is an image adjacent to a current target image, the processor 110 treats the tapping operation as a normal page turning operation. If the tapped image is not an image adjacent to the current target image, the tapping operation is referred to as a jump operation in the present specification.

A usage mode of the user may be to jump to a page far away from a currently viewed page, temporarily view the page, and then return to the original page again. However, in the related art, it is not easy for the user to search for the original page as a jump source in order to return from the page as a jump destination to the original page as the jump source, and it has been desired to improve operability.

The display program 111 causes the processor 110 to implement a function of improving operability in the display apparatus 100. By executing the display program 111, the processor 110 functions as an image acquiring section 111a, an image processing section 111b, and an operation processing section 111c. The image acquiring section 111a causes the processor 110 to implement a function of acquiring the document data 121 to be displayed and acquiring the plurality of images indicating the plurality of respective pages included in the document data 121.

The image processing section 111b causes the processor 110 to implement a function of rotating each of the plurality of images arranged on the first virtual axis Q around a corresponding one of the second virtual axes M intersecting the first virtual axis Q, further rotating the plurality of images around the first virtual axis Q, and displaying the plurality of images on the touch panel display as the display section. In a case where the plurality of images are to be arranged on the first virtual axis Q, and an image randomly selected from among the plurality of images satisfies the predetermined condition, the processor 110 causes the image processing section 111b to make a width of a first interval between the randomly selected image and an image adjacent to the randomly selected image different from the reference width of the first interval in a case where the randomly selected image does not satisfy the predetermined condition.

In the present embodiment, the image satisfying the predetermined condition is a target image before a jump operation of setting, as a new target image, an image that is not adjacent to the target image to which attention is paid among the plurality of images is performed. In a case where an operation performed using the UI section 140 is a specific operation determined in advance in the display program 111, the operation processing section 111c causes the processor 110 to implement a function of performing a process corresponding to the specific operation. In the present embodiment, examples of the specific operation include an operation of shifting a display position of an image in the left-right direction by swiping in the image bundle display region A1 in the left-right direction, an operation of switching a target image by tapping any one of the images in the image bundle, and the like as described above. When the operation of switching a target image is performed, the processor 110 determines whether the operation corresponds to a jump operation by the operation processing section 111c.

When an operation (that is, a normal page turning operation) of setting, as a new target image, an image adjacent to a target image to which attention is paid among the plurality of images is performed, the processor 110 sets, as a reference width, a width of a first interval between the target image before the operation and the new target image by the image processing section 111b. When a jump operation is performed, the processor 110 makes a width of a first interval between a target image before the jump operation and an image adjacent to the target image wider than the reference width. The reference width is a width of an interval between images calculated to arrange the images in each of the static section and the dynamic section. In a case where the first interval is included in the static section, the reference width is a reference width (that is a standard page pitch La calculated as described later) in the static section. In a case where the first interval is included in the dynamic section, the reference width is a reference width in the dynamic section. The reference width in the dynamic section is wider than the reference width in the static section. In addition, the reference width in the dynamic section varies depending on the distance from the central portion K (the reference width in the dynamic section is wider when the distance from the central portion K is short than when the distance from the central portion K is long). In a case where a certain image corresponds to the target image before the jump operation, the width of the first interval of the certain image is adjusted to be wider than the reference width (the reference width is the reference width in the static section when the first interval of the certain image is included in the static section, and is the reference width in the dynamic section when the first interval of the certain image is included in the dynamic section), compared to a case where the certain image does not correspond to the target image.

For example, when an image T_{B} is tapped in the state indicated by (S3) in FIG. 5, the processor 110 sets the image T_{B} as a new target image and displays the image bundle as indicated by (S4) in FIG. 5. Since the new target image T_{B} is not adjacent to the target image T_{A} before the operation, this tapping operation corresponds to a jump operation. When a jump operation from T_{A} to T_{B} is performed, the processor 110 displays the new target image T_{B} and an image T_{B-1} adjacent to the new target image T_{B} in a double-page spread as indicated by (S4). In addition, the target image T_{A} before the operation is in a state of being rotated leftward in the state indicated by (S3) before the jump operation, but the target image T_{A} before the operation is located on the left side of the new target image T_{B} displayed in the double-page spread after the jump operation as indicated by (S4). Therefore, the processor 110 rotates and displays the target image T_{A} before the operation so as to cause the target image T_{A} before the operation to face the right side. The processor 110 rotates and displays the target image T_{A} and the image located on the left side of the double-page spread image such that not only the target image T_{A} but also the image located on the left side of the double-page spread image face the right side.

In the example indicated by (S4), the target image T_{A} before the operation is included in the static section. Although the images in the static section are arranged at equal intervals equal to the reference width (standard page pitch La) in the static section calculated as described later, the processor 110 displays the target image T_{A} before the operation such that a first interval G_{A} between the target image T_{A} before the operation and an image adjacent to the target image T_{A} before the operation is wider than the reference width (La) in the static section as indicated by (S4). With this configuration, it is possible to make the target image T_{A} before the operation noticeable.

In a case where an image satisfying the predetermined condition, that is, a target image before a jump operation in the present embodiment, is located on the left side of a double-page spread image, a first interval for the target image before the jump operation is an interval between the target image before the jump operation and an image adjacent to the target image on the right side of the target image. As indicated by (S4), the image on the left side of the double-page spread image is rotated rightward with respect to the front view. Therefore, since the first interval G_{A} between the target image T_{A} before the operation and the image adjacent to the target image T_{A} on the right side of the target image T_{A} is wider than the reference width (La) in the static section, the content of the target image T_{A} before the operation can be displayed in an easily viewable manner, as compared to a configuration in which the interval between the target image T_{A} before the operation and the image adjacent to the target image T_{A} on the right side of target image T_{A} is not wider than the reference width (La).

In a case where a target image before a jump operation is located on the right side of a double-page spread image, a first interval for the target image before the jump operation is an interval between the target image before the operation and an image adjacent to the target image before the operation on the left side of the target image before the operation. The image on the right side of the double-page spread is rotated leftward with respect to the front view. Therefore, since the width of the first interval between the target image before the operation and the image adjacent to the target image before the operation on the left side of the target image before the operation is wider than the reference width, it is possible to display the content of the target image before the operation in an easily viewable manner.

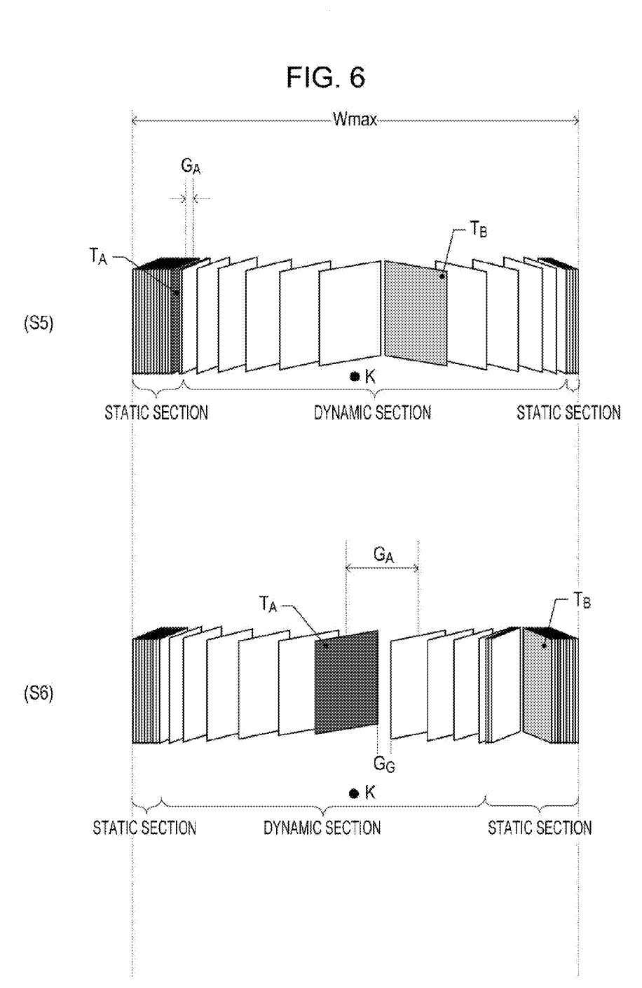

The processor 110 makes the first interval wider in a case where the target image before the jump operation and a portion within the first interval are included in the dynamic section than in a case where the target image before the jump operation and a portion within the first interval are included in the static section. (S5) illustrated in FIG. 6 indicates an example in which the target image T_{A} before the operation and the first interval G_{A} are included in the static section. (S6) illustrated in FIG. 6 indicates a display example in a case where the target image T_{A} before the operation is moved to the dynamic section by the user performing swiping from the left to the right from the state indicated by (S5). As indicated by (S5) and (S6), the processor 110 arranges each of the images such that the first interval G_{A} between the target image T_{A} before the operation and the image adjacent to the target image T_{A} before the operation on the right side of the target image T_{A} before the operation is wider in a case where the target image T_{A} before the operation and the image adjacent to the target image T_{A} before the operation are included in the dynamic section than in a case where the target image T_{A} before the operation and the image adjacent to the target image T_{A} before the operation are included in the static section. Therefore, it is possible to make the target image before the operation noticeable even in the dynamic section.

More specifically, in the present embodiment, in a case where the target image before the operation and a portion within the first interval are included in the dynamic section, the processor 110 widens the first interval such that the target image before the operation does not overlap the images adjacent to the target image. In the example indicated by (S6), the right end of the target image T_{A} before the operation and the left end of the image adjacent to the target image T_{A} on the right side of the target image T_{A} are arranged with a space G_{G} therebetween. Therefore, in the dynamic section, the target image T_{A} before the operation can be made more noticeable than the other images in the dynamic section. This is because, in the example indicated by (S6) in FIG. 6, the other images are displayed so as to at least partially overlap the images adjacent to the other images in the dynamic section, but the image T_{A} and the image adjacent to the target image T_{A} on the right side of the image T_{A} are displayed so as not to overlap each other and so as to be separated from each other with the space G_{G} therebetween. If the image T_{A} is not the target image before the jump operation in (S6), the processor 110 arranges the images including the image T_{A} at intervals as reference widths in the dynamic section (the closer to the central portion K images arranged at an interval as a reference width are, the greater the reference width is in the dynamic section), and the image T_{A} is displayed in a state of partially overlapping and being partially hidden by the image adjacent to the image T_{A} on the right side of the image T_{A}. However, when the target image T_{A} before the jump operation is located in the dynamic section as in the present embodiment, the processor 110 displays the image T_{A} and the image adjacent to the image T_{A} on the right side of the image T_{A} at an interval wider than the reference width in the dynamic section such that the image T_{A} is not hidden by the image adjacent to the image T_{A} on the right side of the image T_{A}.

Further, in the present embodiment, the processor 110 holds a history of the target image before the jump operation. Specifically, for example, the processor 110 stores identification information (for example, a page number) of the target image before the operation. Then, the processor 110 arranges the plurality of images on the first virtual axis Q such that a width of a first interval between a target image that is before a later jump operation and corresponds to the later jump operation and an image that is adjacent to the target image that is before the later jump operation and corresponds to the later jump operation is greater than a width of a first interval between a target image that is before an earlier jump operation and corresponds to the earlier jump operation and an image adjacent to the target image that is before the earlier jump operation and corresponds to the earlier jump operation.

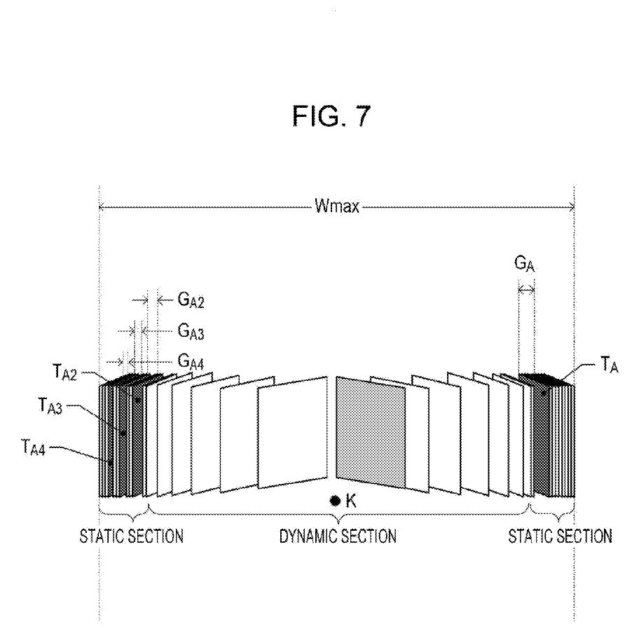

FIG. 7 is a display example in which a jump operation has been performed four times in the past. In the example illustrated in FIG. 7, all of target images before the past four jump operations are included in the static section. The target images before the past four jump operations are T_{A}, T_{A2}, T_{A3}, and T_{A4} from the latest. A first interval for the image T_{A} is G_{A}, a first interval for the image T_{A2} is G_{A2}, a first interval for the image T_{A3} is G_{A3}, and a first interval for the image T_{A4} is G_{A4}. The widths of the first intervals satisfy G_{A4} < G_{A3} < G_{A2} < G_{A}. That is, the images are arranged such that the earlier the jump operation performed on the target image is, the narrower the first interval for the target image is. Therefore, it is possible to make the target images before the jump operations noticeable not only for the latest jump operation but also for the jump operations performed before the latest jump operation. In addition, the target image before the latest jump operation can be made most noticeable. In addition, the user can intuitively recognize whether a target image is before a later jump operation or is before an earlier jump operation according to the magnitude of a first interval for the target image.

Note that the maximum number of jump operation histories to be held may be designed as appropriate in accordance with the usage trend of the user or the like, but in the present embodiment, the processor 110 holds a maximum of five histories for one document data piece 121. Therefore, it is possible to make target images before the latest five jump operations noticeable. As a result, it is possible to make it easy for the user to search for the target images before the latest five jump operations when the user tries to focus on the images again. A history older than the latest five jump operations can be automatically discarded by the processor 110. In a case where a first interval corresponding to a history older than the five jump operations continues to remain wider than the reference width, it may be rather difficult for the user to find a desired page, and usability may be reduced. However, such a possibility can be reduced by automatically deleting the history older than the five jump operations as described above.

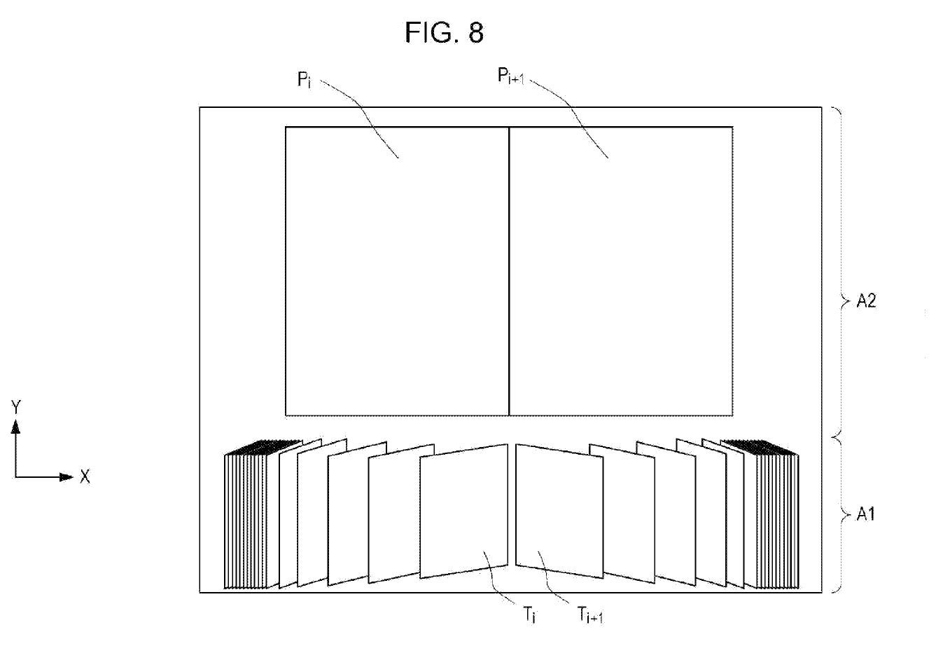

As illustrated in FIG. 2, in a case where a target image is displayed in a single page in the main display region A2 different from the image bundle display region A1, an image satisfying the predetermined condition is a target image before a jump operation of setting, as a new target image, an image separated from the target image by two or more pages is performed. The main display region A2 is not limited to a single-page display as illustrated in FIG. 2, and may be displayed in a double-page spread as illustrated in FIG. 8, for example. When enlarged images Pᵢ and P_{i + 1} of two target images Tᵢ and T_{i + 1} in the image bundle display region A1 are displayed in a double-page spread in the main display region A2 as illustrated in FIG. 8, an image satisfying the predetermined condition is a target image before a jump operation of setting, as a new target image, an image separated from the target image by three or more pages is performed. That is, the definition of a jump operation (the definition of whether an image is adjacent to the target image) differs between a case where the main display region A2 is a single-page display and a case where the main display region A2 is a double-page spread display.

In a case where the main display region A2 is a single-page display, for example, when the target image transitions to 1, 2, 3, 2, 3, 4, and 5 (the numbers indicate page numbers) in this order, each movement is not a movement to a page from which the target image is separated by two or more pages, and thus the processor 110 does not treat the movement as a jump operation. On the other hand, for example, when the target image transitions to 1, 2, 3, 20, 21, 22, and 3 in this order, the movement from the third page to the twentieth page and the movement from the twenty-second page to the third page are movements to pages from which the target image is separated by two or more pages, and thus the processor 110 treats these movements as jump operations. Then, the processor 110 stores the third page as the target image before the operation in the case of the movement from the third page to the twentieth page, and stores the twenty-second page as the target image before the operation in the case of the movement from the twentieth second page to the third page.

In the case of a double-page spread display, for example, when target images transition to (1, 2), (3, 4), (1, 2), (3, 4), (5, 6), and (7, 8) in this order, each movement is not a movement to pages from which the target images are separated by three or more pages, and thus the processor 110 does not treat the movements as jump operations. On the other hand, for example, when target images transition to (1, 2), (3, 4), (5, 6), (9, 10), (11, 12), (13, 14), and (5, 6) in this order, the movement from the fifth and sixth pages to the ninth and tenth pages and the movement from the thirteenth and fourteenth pages to the fifth and sixth pages are movements to pages from which the target images are separated by three or more pages, and thus the processor 110 treats these movements as jump operations. Then, the processor 110 stores the ninth and tenth pages as the target images before the operation in the case of the movement from the fifth and sixth pages to the ninth and tenth pages and stores the thirteenth and fourteenth pages as the target images before the operation in the case of the movement from the thirteenth and fourteenth pages to the fifth and sixth pages.

Therefore, it is possible to distinguish between a movement (corresponding to normal page turning) to an image adjacent to a target image and a movement (corresponding to a jump operation) to an image not adjacent to the target image in each of the case where the main display region A1, which is different from the image bundle display region A2, is a single-page display and the case where the main display region A1 is a double-page spread display.

As described above, according to the present embodiment, when a plurality of images are displayed side by side, an image satisfying the predetermined condition can be made relatively noticeable. In a case where the predetermined condition is a target image before a jump operation, the target image (image as a jump source) before the jump operation can be easily found after the jump operation. There is known a related-art method of performing a specific operation such as adding an electronic tag to a page of interest to make it easy to find the page from a plurality of pages. However, in this method, it is necessary to perform an operation of adding an electronic tag before each jump operation. However, according to the present embodiment, the user can easily find an image before a jump operation without performing an operation such as adding a tag before performing the jump operation. Therefore, the operability of the display apparatus 100 can be improved.

### 2 Display Process

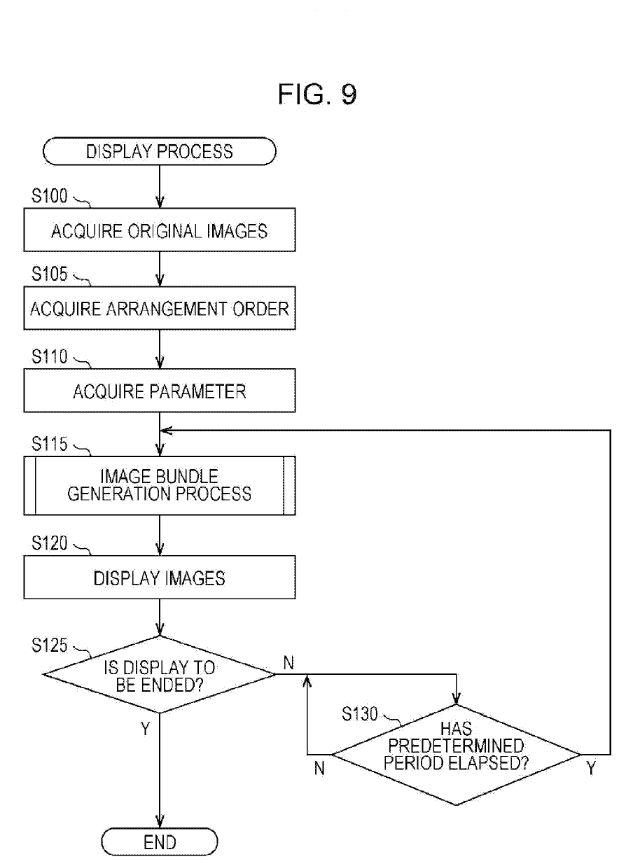

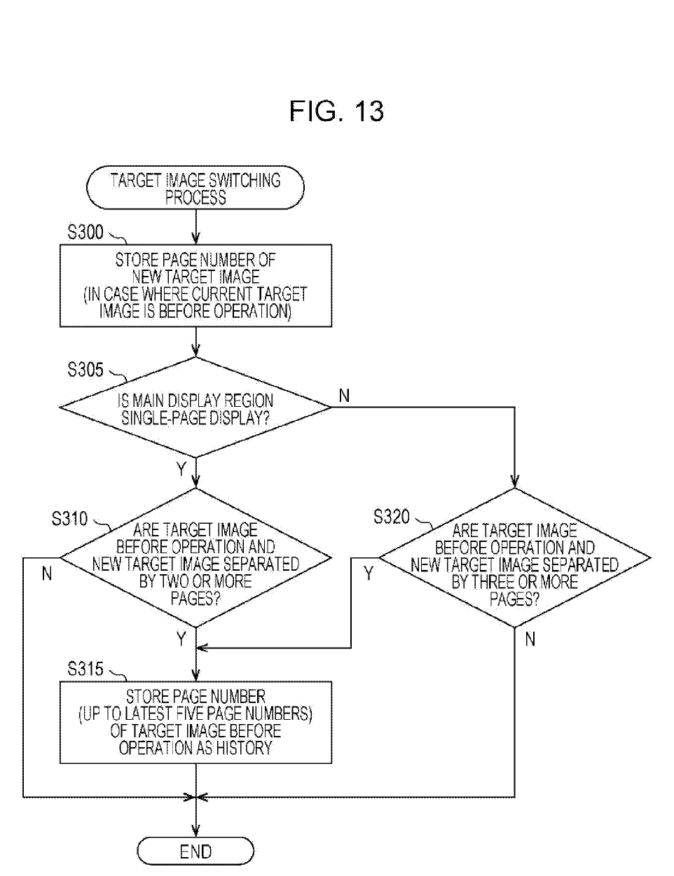

Next, specific processing for implementing the above-described configuration will be described. FIG. 9 is a flowchart illustrating a display process. The display process illustrated in FIG. 9 is started when an instruction to display a viewing screen as illustrated in FIG. 2 or FIG. 8 is issued. Step S115 and step S120 are repeatedly executed at a predetermined time interval (for example, 1/60 seconds) even after the first execution so as to update the displayed content of the display section in the display apparatus 100. When detecting that an operation has been performed on the display apparatus 100 by the user, the processor 110 executes a process corresponding to the content of the operation separately from the display process illustrated in FIG. 9. A target image switching process illustrated in FIG. 13 is a process that is among processes that are performed in response to operations performed by the user, and is executed by the processor 110 when the processor 110 detects that an operation of switching a target image has been performed.

First, the display process illustrated in FIG. 9 will be described. When the display process illustrated in FIG. 9 is started, the processor 110 acquires the original images by the image acquiring section 111a (step S100). That is, the processor 110 acquires the images indicating the plurality of respective pages included in the document data 121 instructed to be viewed by the user. In addition, the processor 110 acquires vertical and horizontal sizes of each of the images. In the present embodiment, the description will be continued on the assumption that all of the original images indicating the pages included in the document data 121 have the same vertical size (height) and the same horizontal size (width).

Subsequently, the processor 110 acquires the arrangement order (step S105). That is, the processor 110 acquires the arrangement order (for example, page numbers) of the images and the total number of the pages by the image acquiring section 111a. Subsequently, the processor 110 acquires a parameter for displaying the viewing screen by the image processing section 111b (step S110). For example, the processor 110 acquires the width (entire occupancy width Wmax (see, for example, FIG. 5)) of the region occupied for displaying the image bundle in the image bundle display region A1, the height of the region, a standard page pitch occupancy width ratio described later, and the like. The processor 110 acquires the width, the height, and the like of the main display region A2. The processor 110 acquires vertical and horizontal sizes of each of thumbnail images (images to be displayed as an image bundle) to be generated based on the original images.

Subsequently, the processor 110 executes an image bundle generation process by the image processing section 111b (step S115). The image bundle generation process is a process of generating images of an image bundle to be displayed in the image bundle display region A1. Details of the process will be described later.

Subsequently, the processor 110 displays the images by the image processing section 111b (step S120). That is, the processor 110 displays the images generated in step S115 in the image bundle display region A1, and displays an enlarged image of a target image in the main display region A2. As a result, in the case of the single-page display, as illustrated in FIG. 2, the image bundle is displayed in the image bundle display region A1, and an enlarged image of one target image in the image bundle is displayed in the main display region A2. In the case of the double-page spread display, as illustrated in FIG. 8, the image bundle is displayed in the image bundle display region A1, and two enlarged images of two target images in the image bundle are displayed in the main display region A2. Note that an "enlarged image" displayed in the main display region A2 indicates an image of an enlarged size based on the size of the target image. The "enlarged image" may not be generated by enlarging the target image, and may be generated, for example, by reducing the original image corresponding to the target image in accordance with the size of the main display region A2.

Subsequently, the processor 110 determines whether to end the display by the image processing section 111b (step S125). That is, the processor 110 determines whether a trigger for ending the display of the viewing screen as illustrated in FIG. 2 or FIG. 8 has been generated. If the processor 110 determines not to end the display in step S125, the processor 110 waits for a predetermined period (for example, 1/60 seconds) to elapse (step S130). If the processor 110 determines that the predetermined period has elapsed, the processor 110 executes the processing in step S115. When a swipe operation, a normal page turning operation, and a jump operation are performed on the image bundle in the process of repeatedly executing step S115 and step S120 at the predetermined time interval, these operations are reflected in the image bundle generation process, the image bundle generation process in which the operations have been reflected is performed in step S115 in the next time interval, and the display is performed in step S120.

### 2-1 Image Bundle Generation Process

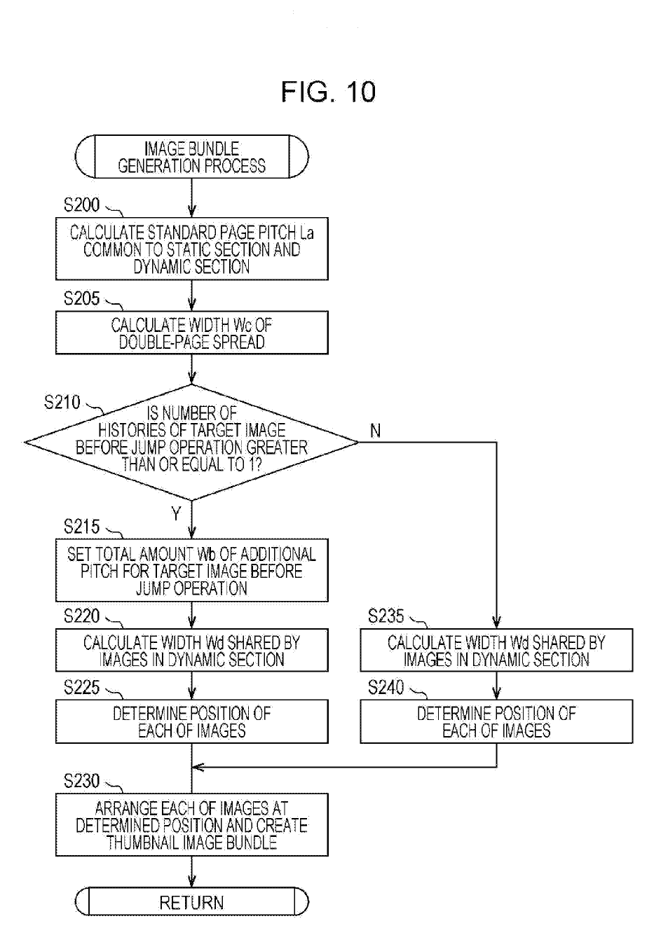

FIG. 10 is a flowchart illustrating the image bundle generation process executed in step S115 illustrated in FIG. 9. The description will be continued on the assumption that page numbers of pages belonging to the dynamic section, page numbers of pages belonging to the static section, page numbers of a double-page spread image, the position of the double-page spread image within the entire occupancy width Wmax, and the like at the time of the execution of the image bundle generation process are determined in accordance with the status of a swipe operation in the left-right direction in the image bundle display region A1 or the like. When the image bundle generation process is started, the processor 110 calculates the standard page pitch La common to the static section and the dynamic section (step S200).

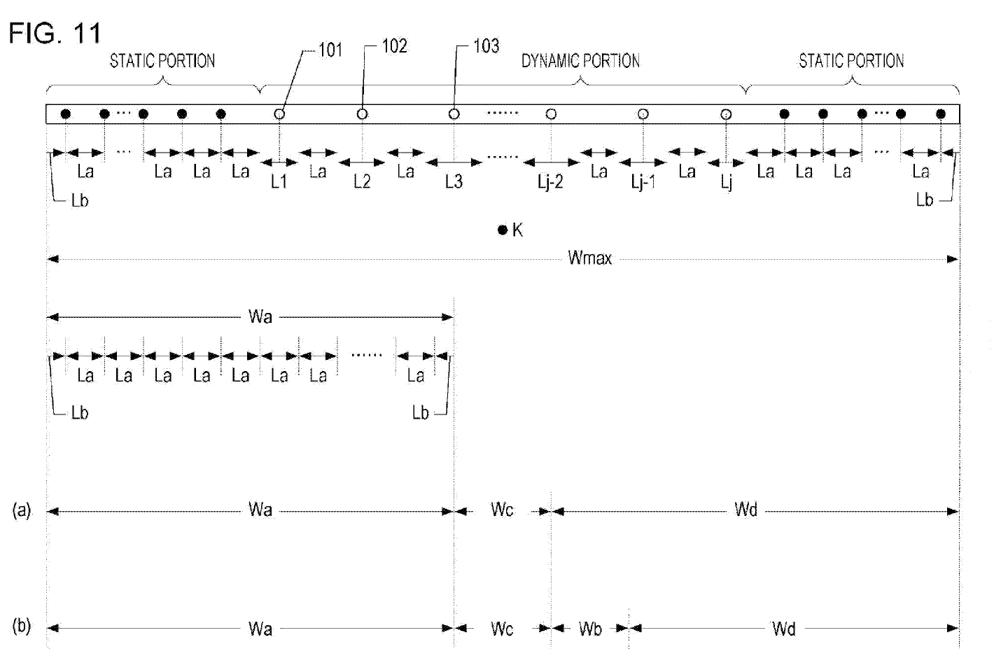

The standard page pitch La is calculated by "the entire occupancy width Wmax × the standard page pitch occupancy width ratio / (the total number of the pages - 1)". The standard page pitch occupancy width ratio is a ratio of a length (occupancy width) from the position of the midpoint of the first page in the width direction to the position of the midpoint of the last page in the width direction to the entire occupancy width Wmax when the images of all the pages are arranged at intervals equal to the standard page pitch. FIG. 11 is a diagram schematically illustrating an example of intervals (pitches) between the images in a case where a jump operation has not been performed yet. In FIG. 11, each black circle indicates the position of the midpoint of an image included in the static section in the width direction, and each white circle indicates the position of the midpoint of an image included in the dynamic section in the width direction.

As illustrated in FIG. 11, the standard page pitch La is a reference width of each of intervals between images in the static section. In the present embodiment, in the dynamic section, dynamic pitches L1, L2, L3, ---, and Lj for changing intervals between images in the dynamic section are inserted between standard page pitches La. In this case, j is the number of intervals between the images included in the dynamic section. In a case where a double-page spread image is included in the dynamic section, an interval between two images constituting the double-page spread image is not counted as j (the interval between the two images included in the double-page spread image is separately set). Each of the dynamic pitches L1, L2, L3, ---, and Lj is calculated by the processor 110 such that the closer to the central portion K the dynamic pitch is, the longer the dynamic pitch is. While the reference width of each of the intervals between the images in the static section is constant at La, each of the reference widths of the intervals between the images in the dynamic section is the standard page pitch La + α. In this case, α varies depending on the distance from the central portion K. For example, in the example illustrated in FIG. 11, an interval between adjacent images 101 and 102 in the dynamic section is the standard page pitch La + L1 / 2 + L2 / 2 (α = L1 / 2 + L2 / 2). Similarly, an interval between the image 102 and an image 103 is the standard page pitch La + L2 / 2 + L3 / 2 (α = L1 / 2 + L2 / 2). In this example, since L3 > L2 > L1 is satisfied, the interval between the image 102 and the image 103 is wider than the interval between the image 101 and the image 102. Note that widths Lb at both ends of the entire occupancy width Wmax indicate widths for displaying, for example, the left half of the first page and the right half of the last page, respectively. The sum of the two widths Lb at both ends and ((the total number of the pages - 1) × the standard page pitch La) is Wa.

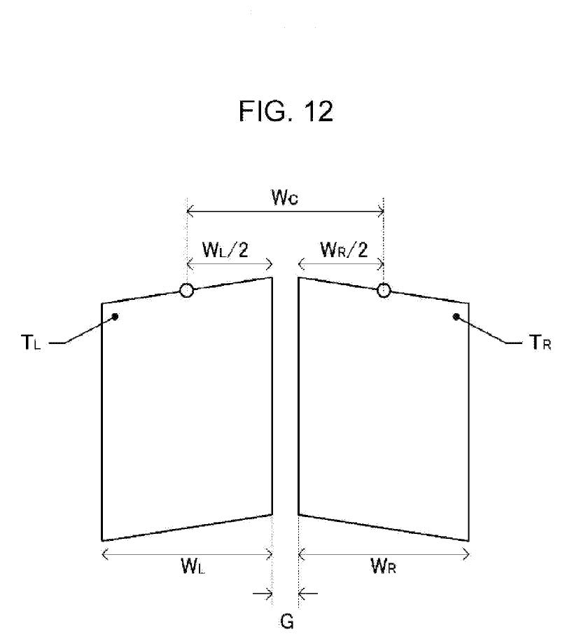

Subsequently, the processor 110 calculates a width Wc of the double-page spread image (step S205). FIG. 12 is a schematic diagram illustrating an example of the width of the double-page spread image. For example, the width Wc of the double-page spread image is expressed by W_{L} / 2 + G + W_{R} / 2. W_{L} is a length of the left image T_{L} of the double-page spread image in the direction parallel to the X axis when the left image T_{L} rotated by an angle θ around a second virtual axis M of the left image T_{L} and rotated by a predetermined angle φ around the first virtual axis Q is projected onto the XY plane. W_{R} is a length of the right image T_{R} of the double-page spread image in the direction parallel to the X axis when the right image T_{R} rotated by the angle θ around a second virtual axis M for the right image T_{R} and rotated by the predetermined angle φ around the first virtual axis Q is parallel-projected onto the XY plane. The absolute value of θ in a case where the position of the image is closer to the central portion K is less than in a case where the position of the image is farther from the central portion K. Φ is a predetermined value. For example, the width of the interval G between the images included in the double-page spread image in a case where the double-page spread image is present in the dynamic section is set to be greater than that in a case where the double-page spread image is present in the static section.

Subsequently, the processor 110 determines whether one or more histories of a target image before a jump operation are stored (step S210). If the processor 110 determines that one or more histories of the target image before the jump operation are not stored in step S210, the processor 110 calculates a width Wd shared by images in the dynamic section (step S235). For example, as indicated by (a) in FIG. 11, the processor 110 sets the width Wd to Wmax - Wa - Wc. The processor 110 sets the width Wd as a width divided into the dynamic pitches L1, L2, L3, ---, and Lj.

Subsequently, the processor 110 determines the position of each of the images (step S240). The processor 110 divides the width Wd indicated by (a) in FIG. 11 into the dynamic pitches L1, L2, L3, ---, and Lj. The processor 110 determines the values of the dynamic pitches L1, L2, L3, ---, and Lj such that the greater the value of the dynamic pitch is, the closer to the central portion K the dynamic pitch is. The processor 110 sets the interval between the two images constituting the double-page spread image to Wc. For the other images, the processor 110 sets an interval between images in the static section to La, and sets an interval between images in the dynamic section to La + α as described above. The processor 110 determines the widths of the intervals between the images in the above-described manner, and determines the X coordinate of the midpoint of each of the images in the width direction in a case where the images are to be arranged in the order of the pages from the left within the entire occupancy width Wmax.

If the processor 110 determines in step S210 that one or more histories of the target image before the jump operation are stored, the processor 110 sets a total amount Wb of an additional pitch for the target image before the jump operation (step S215). The additional pitch is a total amount of a width to be added to make the first interval of the target image before the jump operation wider than the reference width. For example, in a case where two histories of the target image before the jump operation are present, the processor 110 divides the total amount Wb of the additional pitch into two.

Subsequently, the processor 110 calculates the width Wd shared by the images in the dynamic section (step S220). For example, as indicated by (b) in FIG. 11, the processor 110 sets the width Wd to Wmax - Wa - Wc - Wb. The processor 110 sets the width Wd as a width divided into the dynamic pitches L1, L2, L3, ---, and Lj.

Subsequently, the processor 110 determines the position of each of the images (step S225). The processor 110 determines a width of an individual additional pitch to be added to the first interval of the target image before the jump operation and the widths of the respective dynamic pitches L1, L2, L3, ---, and Lj in accordance with the following policies.

As one of the policies, in a case where the target image before the jump operation is included in the dynamic section, the processor 110 calculates an additional pitch for arranging the target image and the image adjacent to the target image with the interval G_{G} between the target image and the image adjacent to the target image so as not to cause the target image to overlap the adjacent image as indicated by (S6) in FIG. 6, and adds the additional pitch to the standard page pitch La + α to obtain the first interval G_{A}.

In addition, in a case where the target image before the jump operation is present in the static section, the processor 110 sets, as the width of the first interval G_{A}, a width obtained by adding the additional pitch to La which is the reference width in the static section as indicated by (S5) in FIG. 6. In a case where a plurality of (a maximum of five target images in the present embodiment) target images before a jump operation are included in the static section, the processor 110 sets an additional pitch to be added to La to a larger value for a target image that is before a later jump operation and corresponds to the later jump operation. As a result, a width of a first interval corresponding to the later jump operation is wider than a width of a first interval corresponding to an earlier jump operation.

In a case where a plurality of target images before a jump operation are present in the dynamic section, Wb may be divided such that a width of a first interval for a target image before a later jump operation among the target images is wider than a width of a first interval for a target image before an earlier jump operation among the target images.

In a case where a target image before a jump operation is present on the left side of a double-page spread image, the processor 110 adds an additional pitch to an interval on the right side of the target image before the operation. In a case where the target image before the jump operation is present on the right side of the double-page spread image, the processor 110 adds an additional pitch to an interval on the left side of the target image before the operation.

In addition, the processor 110 determines the values of the dynamic pitches L1, L2, L3, ---, and Lj by dividing Wd into the dynamic pitches L1, L2, L3, ---, and Lj such that the greater the value of the dynamic pitch is, the closer to the central portion K the dynamic pitch is.

The processor 110 sets the interval between the two images constituting the double-page spread image to Wc. For the other images, the processor 110 sets an interval between images in the static section to La, and sets an interval between images in the dynamic section to La + α as described above. However, in a case where a first interval of a target image before a jump operation is present in the static section, the processor 110 sets the first interval to the width of La + an additional pitch. When the first interval of the target image before the jump operation is present in the dynamic section, the processor 110 sets the first interval to the width of La + α + the additional pitch. The processor 110 determines the widths of the intervals between the images in the above-described manner and determines the X coordinate of the midpoint of each of the images in the width direction in a case where the images are to be arranged in the order of the pages from the left within the entire occupancy width Wmax.

After executing step S225, alternatively, after executing step S240, the processor 110 arranges the images at the determined positions and generates a thumbnail image bundle (step S230). That is, the processor 110 reduces each of the original images indicating the respective pages to the size of a thumbnail image, and generates thumbnail images to be displayed as an image bundle. As described above, the processor 110 generates the images by rotating each of the images (thumbnail images) arranged at the respective determined positions around a corresponding one of the second virtual axes M intersecting the first virtual axis Q, and further rotating the images around the first virtual axis Q. Then, the processor 110 generates the image bundle in which the images generated in the above-described manner are arranged at the respective determined positions.

### 3 Target Image Switching Process

FIG. 13 is a flowchart illustrating a target image switching process among processes performed in response to an operation performed on the UI section 140 of the display apparatus 100 by the user. In the present embodiment, the target image switching process is executed when the user taps an image other than a current target image in the image bundle displayed in the image bundle display region A1. The target image switching process is executed by the processor 110 using a function of the operation processing section 111c. When the target image switching process is started, the processor 110 stores the page number of the new target image (step S300). That is, the processor 110 identifies the page number of the image currently displayed at a position tapped by the user, and stores the page number as the page number of the new target image. The processor 110 sets, as a target image before the operation, the target image before the new target image is identified.

Subsequently, the processor 110 determines whether the main display region A2 is a single-page display (step S305). If the processor 110 determines in step S305 that the main display region A2 is a single-page display, the processor 110 determines whether the target image before the operation and the new target image are separated from each other by two or more pages (step S310). If the processor 110 determines in step S310 that the target image before the operation and the new target image are not separated from each other by two or more pages, the processor 110 ends the target image switching process.

If the processor 110 determines in step S310 that the target image before the operation and the new target image are separated from each other by two or more pages, that is, if the processor 110 determines in step S310 that a jump operation has occurred, the processor 110 stores the page number of the target image before the operation as a history (step S315). In the present embodiment, the processor 110 secures a storage region in which a maximum of five page numbers can be held as a history. In the storage region, the page number is stored in such a manner that the chronological order of occurrence of a jump operation can be identified. The processor 110 stores, as a page number of a target image that is before the latest jump operation performed and corresponds to the latest jump operation, the page number of the page set as the target image before the operation in step S300. In a case where five page numbers have already been stored, the processor 110 discards a page number of a target image that is before the earliest jump operation and corresponds to the earliest jump operation.

If the processor 110 determines in step S305 that the main display region A2 is not a single-page display, that is, in a case where the main display region A2 is a double-page spread display, the processor 110 determines whether the target image before the operation and the new target image are separated from each other by three or more pages (step S320).

If the processor 110 determines in step S320 that the target image before the operation and the new target image are separated from each other by three or more pages, that is, if the processor 110 determines that a jump operation has occurred, the processor 110 executes step S315. If the processor 110 determines in step S320 that the target image before the operation and the new target image are not separated from each other by three or more pages, the processor 110 ends the target image switching process. In steps S115 and S120 of the display process (illustrated in FIG. 9) executed after the end of the target image switching process, the page number of the new target image switched in the target image switching process and the history of the page number of the target image before the jump operation are referred to.

### 4 Other Embodiments

The above-described embodiment is merely an example of implementing the present disclosure, and various other embodiments may also be adopted. For example, the display method described above in the embodiment can also be applied as a display method in a display apparatus such as a head-mounted display in addition to a smartphone, a tablet, and a PC. The operations on the display apparatus are not limited to the operation on the touch panel display and the operation using the pointing device, and various other gesture operations may be employed.

The image satisfying the predetermined condition is not limited to the target image before the jump operation. For example, the predetermined condition may be an image that is viewed at a frequency higher than a predetermined reference, an image that is viewed for a period of time longer than a predetermined reference period, an image that is viewed every time a certain document is viewed, or the like. Further, for example, in a case where the document is constituted by a unit such as a part, a chapter, a section, or a subsection, the predetermined condition may be a first image of an image group included in the unit.

In a case where the plurality of images are to be arranged on the first virtual axis, and an image randomly selected from among the plurality of images satisfies the predetermined condition, the image processing section makes a width of a first interval between the randomly selected image and an image adjacent to the randomly selected image different from a reference width of the first interval in a case where the randomly selected image does not satisfy the predetermined condition. The width of the first interval in the case where the predetermined condition is satisfied may be different from the width of the first interval in the case where the predetermined condition is not satisfied, and the former width may be wider than the latter width, or the former width may be narrower than the latter width. Even in a case where the former width is narrower than the latter width, a randomly selected image satisfying the predetermined condition can be made more noticeable than the other images as long as an interval between the randomly selected image and an image adjacent to the randomly selected image is different from the widths of intervals between the other images and the images adjacent to the other images.

In the display apparatus, the main display region A2 as illustrated in FIG. 2 and FIG. 8 is not necessarily provided, and at least the image bundle display region A1 may be provided on the screen.

The present disclosure is not limited to a configuration in which both the static section and the dynamic section are included in the image bundle. Any one of the static section and the dynamic section may be included in the image bundle. Further, an absolute value of a rotation angle of an image around a second virtual axis for the image in the static section may be greater than an absolute value of a rotation angle of an image around a second virtual axis for the image in the dynamic section as in the above-described embodiment, or may be equal to the absolute value of the rotation angle of the image around the second virtual axis for the image in the dynamic section. In addition, the absolute value of the rotation angle of the image around the second virtual axis for the image in the dynamic section may vary depending on the positional relationship with the central portion K as in the above-described embodiment, but may be constant regardless of the positional relationship with the central portion K.

The image processing section may be able to set a width of a first interval wider in a case where an image satisfying the predetermined condition and a portion within the first interval are included in the dynamic section than in a case where the image satisfying the predetermined condition and the portion within the first interval are included in the static section. In the above-described embodiment, the example has been described in which the width of the first interval in such a case is widened such that the image satisfying the predetermined condition does not overlap an image adjacent to the image satisfying the predetermined condition. However, the image satisfying the predetermined condition may partially overlap the adjacent image as long as the width is wider than that in the case where the image satisfying the predetermined condition and the portion within the first interval are included in the static section.

In a case where drawing is omitted for at least one of images in the static section, a configuration may be adopted in which an image satisfying the predetermined condition and included in the static section is excluded from the at least one image for which the drawing is omitted. For example, (S5) in FIG. 6 indicates the example in which the target image T_{A} before the jump operation is present in the static section. In the static section, since an interval between images is narrower than that in the dynamic section, a region in which adjacent images overlap each other is large, and it is difficult to visually recognize the content of the images due to the presence of the overlapping images. For at least one of images in the static section which is difficult to visually recognize, a frame indicating the shape of the image is drawn, and the drawing of the image in the frame is omitted. Therefore, it is possible to shorten the processing time for the processing of drawing the image in the static section. Basically, in a case where drawing is omitted for at least one of the images in the static section, and an image satisfying the predetermined condition is included in the static section, the drawing of the image may not be omitted and the image may be exceptionally drawn. Since an image satisfying the predetermined condition is adjacent to an image with an interval wider than the reference width in the static section, a region in which the image satisfying the predetermined condition does not overlap the adjacent image is wider than an image in the static section in a normal case. Therefore, by performing drawing without omission in the above-described manner, it is possible to display the content of the image satisfying the predetermined condition.

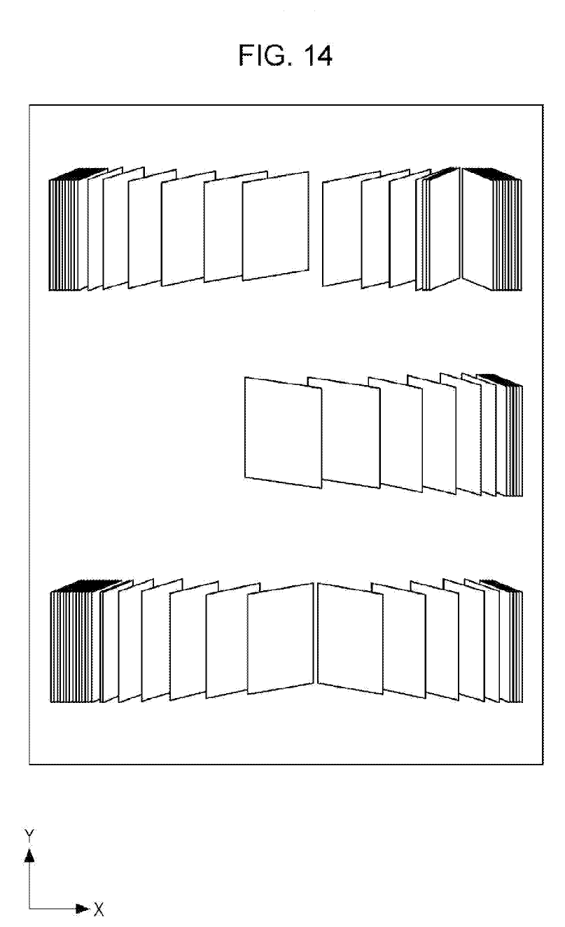

Further, a usage mode of the user may be to view a plurality of documents while switching between the plurality of documents. For example, while a certain document is being viewed as illustrated in FIG. 2, a list (also referred to as a document list) of documents that can be referred to on the display apparatus 100 may be displayed in order to refer to another document, and a page on which desired information is described may be searched from a plurality of other documents included in the document list. To display the list of the plurality of documents, for example, as illustrated in FIG. 14, each of the documents is displayed in the form of an image bundle described above in the embodiment. That is, for each document, the processor 110 rotates each of a plurality of images arranged on the first virtual axis around a corresponding one of the second virtual axes intersecting the first virtual axis, further rotates the plurality of images around the first virtual axis, and displays the plurality of images on the display section. Then, in a case where the plurality of images are to be arranged on the first virtual axis for each of the documents, and an image randomly selected from among the plurality of images satisfies the predetermined condition, the processor 110 makes a first interval between the randomly selected image and an image adjacent to the randomly selected image different from a first interval between the randomly selected image and the image adjacent to the randomly selected image in a case where the randomly selected image does not satisfy the predetermined condition.

Therefore, it is possible to make an image satisfying the predetermined condition noticeable for each of the documents. In a case where the image satisfying the predetermined condition is a target image before a jump operation, it is possible to make the image before the jump operation performed in the past for each document noticeable, and it is possible to easily search for the image. The jump operation may include not only a jump within a document but also a jump from an image of a certain document to an image of another document (for example, in a state where an image of a first page of a first document is set as a target image, an image of a second page of a second document is set as a target image). For example, for each document, five histories of a target image (inside and outside a document) before a jump operation may be held.

A display system including the display apparatus as described above and a server may be configured. The display system may be configured to cause the display apparatus to synchronize, with the server, document information reflecting the content of an operation performed on a single document including a plurality of images. In the display system, document information reflecting the content of a first operation for changing a first interval for a document may not be synchronized with the server when the first operation is performed on the document, and document information reflecting the content of a second operation determined in advance as an operation that is performed less frequently than the first operation and the content of the first operation may be synchronized with the server when the second operation is performed on the document. For example, the jump operation described above in the embodiment may be assumed as the first operation which makes the width of the first interval of the image satisfying the predetermined condition different from the reference width. The second operation may be an operation determined in advance to be performed less frequently than the jump operation. The second operation may be an operation by the user to write a memo, a figure, or the like on an image via the UI section, an operation of attaching an electronic tag, mark, or line via the UI section, an operation of closing a file of the document in the display program 111, an operation of opening an application other than the display program 111, or the like.

The display apparatus does not transmit the content of the first operation (for example, a page number of a target image before the operation in the case of the jump operation) to the server every time the first operation is performed. The display apparatus stores the content of the first operation on the display apparatus side until the second operation is performed next, and transmits, to the server, the stored content of the first operation together with the content of the second operation when the second operation is performed next. Therefore, it is possible to prevent an increase in the communication load between the server and the display apparatus.

In addition, the present disclosure may also be applied as a program and a method that are executed by a computer. Further, the system, the program, and the method as described above may be implemented as a single apparatus or may be implemented by using components included in a plurality of apparatuses, and include various aspects. The configuration described above may also be modified such that the configuration is implemented by a combination of software and hardware. Furthermore, the present disclosure may also be implemented as a storage medium that stores a program for controlling the system. The storage medium that stores the program may be a magnetic storage medium or a semiconductor memory, and the same applies to any storage medium that will be developed in the future.

What is claimed is:

1. A display method that rotates each of a plurality of images arranged on a first virtual axis around a corresponding one of second virtual axes intersecting the first virtual axis, further rotates the plurality of images around the first virtual axis, and displays the plurality of images on a display section, the display method comprising:
in a case where the plurality of images are to be arranged on the first virtual axis, and an image randomly selected from among the plurality of images satisfies a predetermined condition, making a width of a first interval between the randomly selected image and an image adjacent to the randomly selected image different from a reference width of the first interval in a case where the randomly selected image does not satisfy the predetermined condition.

2. The display method according to claim 1, wherein
the image satisfying the predetermined condition is a target image before a jump operation of setting, as a new target image, an image that is not adjacent to the target image to which attention is paid among the plurality of images is performed,
when the jump operation is performed, a width of the first interval between the target image before the jump operation and the image adjacent to the target image is set to be wider than the reference width, and
when an operation of setting, as a new target image, the image adjacent to the target image to which attention is paid among the plurality of images is performed, the width of the first interval between the target image before the operation and the new target image is set to be equal to the reference width.

3. The display method according to claim 2, further comprising:
holding a history of the target image before the jump operation, wherein
the plurality of images are arranged on the first virtual axis such that a width of a first interval between a target image that is before a later jump operation and corresponds to the later jump operation and an image that is adjacent to the target image that is before the later jump operation and corresponds to the later jump operation is greater than a width of a first interval between a target image that is before an earlier jump operation and corresponds to the earlier jump operation and an image adjacent to the target image that is before the earlier jump operation and corresponds to the earlier jump operation.

4. The display method according to claim 3, wherein
a number of histories held is less than or equal to 5.

5. The display method according to claim 1, wherein
in a case where the plurality of images are divided into
a static section in which images are arranged at equal intervals and in which in a case where the image satisfying the predetermined condition and a portion within the first interval are included in the static section, intervals that are other than the first interval and between which images are arranged are equal, and
a dynamic section in which adjacent images are arranged at an interval wider than the intervals in the static section, and
the width of the first interval in a case where the image satisfying the predetermined condition and the portion within the first interval are included in the dynamic section is set to be wider than the width of the first interval in a case where the image satisfying the predetermined condition and the portion within the first interval are included in the static section.

6. The display method according to claim 5, wherein
in a case where the image satisfying the predetermined condition and the portion within the first interval are included in the dynamic section, the width of the first interval is set so as not to cause the image satisfying the predetermined condition to overlap the image adjacent to the image satisfying the predetermined condition.

7. The display method according to claim 1, wherein
in a case where an enlarged image of a target image to which attention is paid among the plurality of images is displayed in a region different from the plurality of images,
when the enlarged image is displayed in a single page in the different region, the image satisfying the predetermined condition is before a jump operation of setting, as a new target image, an image separated from the target image to which attention is paid among the plurality of images by two or more pages is performed, and
when the enlarged image is displayed in a double-page spread in the different region, the image satisfying the predetermined condition is before a jump operation of setting, as a new target image, an image separated from the target image to which attention is paid among the plurality of images by three or more pages is performed.

8. The display method according to claim 1, wherein
when an image on a left side of a double-page spread image including two images displayed in a double-page spread among the plurality of images on the first virtual axis is rotated around a corresponding second virtual axis among the second virtual axes rightward with respect to a state of a front view of the image, an image on a right side of the double-page spread image on the first virtual axis is rotated around a corresponding second virtual axis among the second virtual axes leftward with respect to a state of a front view of the image, and the rotated images are displayed,
on the left side of the double-page spread image, the first interval is an interval between the image satisfying the predetermined condition and an image adjacent to the image satisfying the predetermined condition on a right side of the image satisfying the predetermined condition,
on the right side of the double-page spread image, the first interval is an interval between the image satisfying the predetermined condition and an image adjacent to the image satisfying the predetermined condition on a left side of the image satisfying the predetermined condition, and
the width of the first interval in a case where the predetermined condition is satisfied is wider than the reference width of the first interval in a case where the predetermined condition is not satisfied.

9. The display method according to claim 5, wherein
in a case where drawing is omitted for at least one of the images in the static section, the image satisfying the predetermined condition and included in the static section is excluded from the at least one image for which the drawing is omitted.

10. The display method according to claim 1, wherein
to display a list of a plurality of documents,
each of a plurality of images arranged on the first virtual axis is rotated around a corresponding one of second virtual axes intersecting the first virtual axis, further rotated around the first virtual axis, and displayed on the display section for each of the documents, and
in a case where the plurality of images are to be arranged on the first virtual axis, and an image randomly selected from among the plurality of images satisfies the predetermined condition, a first interval between the randomly selected image and an image adjacent to the randomly selected image is set to be different from a first interval between the randomly selected image and the image adjacent to the randomly selected image in a case where the randomly selected image does not satisfy the predetermined condition for each of the documents.

11. The display method according to claim 1, wherein
in a system that includes a server and an apparatus including the display section and causes the apparatus to synchronize, with the server, document information reflecting a content of an operation performed on a document including the plurality of images,
when a first operation of changing the first interval is performed on the document, the apparatus does not synchronize, with the server, document information reflecting a content of the first operation, and
when a second operation determined to be an operation that is performed less frequently than the first operation is performed on the document, the apparatus synchronizes, with the server, document information reflecting a content of the second operation and the content of the first operation.

12. A non-transitory computer-readable storage medium storing a display program, the display program causing a computer to function as:
an image acquiring section that acquires a plurality of images to be displayed; and
an image processing section that rotates each of the plurality of images arranged on a first virtual axis around a corresponding one of second virtual axes intersecting the first virtual axis, further rotates the plurality of images around the first virtual axis, and displays the plurality of images on a display section, wherein
in a case where the plurality of images are to be arranged on the first virtual axis, and an image randomly selected from among the plurality of images satisfies a predetermined condition, the image processing section makes a first interval between the randomly selected image and an image adjacent to the randomly selected image different from a first interval between the randomly selected image and the image adjacent to the randomly selected image in a case where the randomly selected image does not satisfy the predetermined condition.
